(19) United States
(12) Patent Application Publication
(10) Pub. No.: US 2018/0049373 A1
(43) Pub. Date: Feb. 22, 2018

(54) AMERICAN HIGH-TECH EARTH SOIL RECOVERY METHOD

(71) Applicants: ERVIN HEN TSAY, Taipei City (TW); CORIGIN INTERNATIONAL INSTITUTE, Taipei City (TW)

(72) Inventors: YU TUNG WU, Taipei City (TW); ERVIN HEN TSAY, Taipei City (TW)

(21) Appl. No.: 15/242,212

(22) Filed: Aug. 19, 2016

(51) Int. Cl. A01G 1/00; C09K 17/04; C09K 17/06; C09K 17/08; C05D 9/02; C05B 17/00; C05D 5/00; C05D 3/00; C05D 1/00; C05G 3/00; C05B 19/00

(52) U.S. Cl. CPC A01G 1/001; C09K 17/04; C09K 17/06; C09K 17/08; C05D 9/02; C05B 19/00; C05D 5/00; C05D 3/00; C05D 1/00; C05G 3/0058; C05D 1/005; C05B 17/00

(57) ABSTRACT

An American high-tech earth soil recovery method, characterized in that, the earth soil contains 108 soil trace elements, comprising the following steps: preparing a powder of nano-particles for the soil trace elements; and spraying the powder into soil infertile, acidified, or contaminated by heavy metals, and through an antagonistic (exchange) effect of the soil trace elements incurred by the powder (electrolyte) potential, the earth soil is recovered, so that in growing a crop, even if the earth soil is contaminated by heavy metals, the heavy metals are not absorbed, and the crop grows by absorbing the added soil trace elements in the soil. Through the inter-molecular antagonism/coordination/absorption/penetration, the earth soil structure is restored, to recover the earth soil for repeated usages, hereby strengthening constitution of a crop, and raising its quality and yield.

### BACKGROUND OF THE INVENTION

### Field of the Invention

The present invention relates to an earth soil recovery method, and in particular to an American high-tech earth soil recovery method, that makes use of antagonistic (exchange) effect of soil trace elements, to recover effectively the earth soil being acidified, infertile, or contaminated by heavy metals.

### The Prior Arts

In general, heavy metal is referred to as a metal having density greater than 5 g/cm³, such as arsenic (As), cadmium (Cd), chromium (Cr), Mercury (Hg), Nickel (Ni), Lead (Pb), Zinc (Zn), and copper (Cu), that may enter into human body through food, respiration, or direct contact. Once getting into a human body, the heavy metals are liable to be deposited in the organ, such as brain or kidney, to damage their functions gradually. Most of the heavy metals in human body tend to bond with protein, nucleic acid (DNA. RNA). The major function of protein in an organism is to perform enzyme reaction. When heavy metals are bonded to the enzymes, that could reduce or eliminate the activities of the enzymes. In addition, when heavy metals are bonded to nucleic acid, that could lead to structure change of nucleic acid and mutation of gene, thus adversely affecting the hereditary of cells, to produce deformed fetus or cause cancer diseases.

In the modern society presently, due to the rapid growth and developments of the Business and Industries, the earth soil is contaminated by heavy metals of the following sources: the industrial waste and waste water produced in the manufacturing process, and the exhaust produced by burning petroleum in the petrochemical industry or burning the scrap metals. The heavy metals are absorbed by the plants, and then they get into human body through the food chain, to affect adversely the health of human.

Therefore, presently, the earth soil contamination problem has not been solved quite satisfactorily, and it leaves much room for improvement.

### SUMMARY OF THE INVENTION

In view of the problems and drawbacks of the prior art, the present invention provides an American high-tech earth soil recovery method, to overcome the shortcomings of the prior art. In which, antagonistic (exchange) effect of soil trace elements is utilized, to recover effectively the earth soil being acidified, infertile, or contaminated by the heavy metals.

The present invention provides an American high-tech earth soil recovery method, characterized in that, the earth soil contains 108 soil trace elements, comprising the following steps: preparing a powder of nano-particles for the soil trace elements; and spraying the powder onto earth soil infertile, acidified, or contaminated by heavy metals, and through an antagonistic (exchange) effect of the soil trace elements incurred by the powder (electrolyte) potential, the earth soil is recovered, so that in growing a crop, even if the earth soil is contaminated by heavy metals, the heavy metals are not absorbed, the crop grows by absorbing the added soil trace elements in the earth soil.

In an aspect of the present invention, the powder contains 26 active soil trace elements that can be quantified, and that include: iron (Fe), nickel (Ni), manganese (Mn), copper (Cu), zinc (Zn), boron (B), molybdenum (Mo), chlorine (Cl), oxygen (O), sodium (Na), magnesium (Mg), aluminum (Al), silicon (Si), a phosphorus (P), sulfur (S), potassium (K), calcium (Ca), scandium (Sc), titanium (Ti), chromium (Cr), vanadium (V), gallium (Ga), selenium (Se), germanium (Ge), lanthanum (La), samarium (Sm), and cobalt (Co), the active soil trace elements act in cooperation with various probiotic micro-organism groups, and through the inter-molecular antagonism/coordination/absorption/penetration, the structure of earth soil is restored, to recover the earth soil for repeated usages, thus strengthening constitution of a crop, and raising its quality and yield.

In another aspect of the present invention, when the powder is sprayed onto the earth soil, the oxidation-reduction potential of the earth soil is turned to −150 mv, at this time, sulfate is reduced to produce the antagonistic effect, to restore the earth soil into achieving acid-base balance.

In yet another aspect of the present invention, the powder is formed through sintering it in a temperature of 1200° C. to 1600° C., to form into a granular-shape.

The particle of the earth soil carries positrons and electrons at the same time, when the pH value is raised, that induces the nitride to release a (positively charged) proton (releasing H+), thus itself becomes negatively charged, to be helpful in absorbing cations. On the contrary, when the pH value is lowered, the NH₂ will accept proton to become positively charged, to be helpful in absorbing anions.

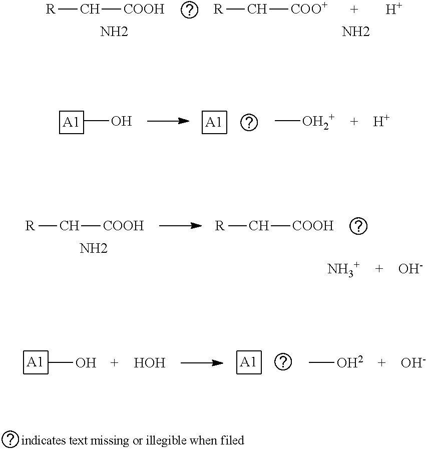

Based on the oxidation-reduction potential of the earth soil, the permeability of the earth soil can be classified into four categories: 1. earth soil of good permeability for (oxidation-reduction potential of) +700 mv to +400 mv; 2. moderately reduced earth soil for +400 mv to +100 mv; 3. normally reduced earth soil for +100 mv to −100 mv; 4. well reduced earth soil for −100 mv to −300 mv. In general, at oxidation-reduction potential of +340 mv, the oxygen contents in earth soil is still sufficient. When the oxidation-reduction potential is at +225 mv, nitride starts to be reduced; at +200 mv, the Mn ion starts to be reduced; at +120 mv, the iron ion starts to be reduced; and finally at −150 mv, sulfate starts to be reduced to produce antagonistic (exchange) effect, to restore the earth soil back into acid-base balance.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of the powder sintered into various granular-shapes according to an embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

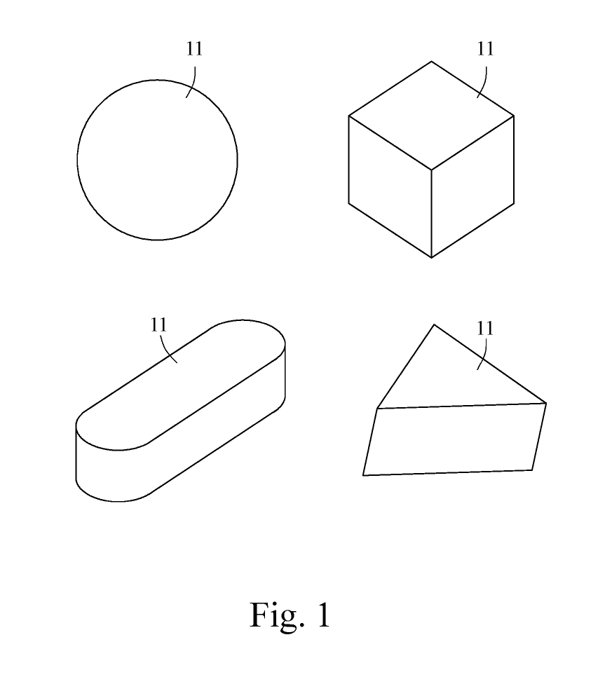

Refer to FIG. 1 for a schematic diagram of the powder sintered into various granular-shapes according to an embodiment of the present invention.

The present invention provides an American high-tech earth soil recovery method, characterized in that, the earth soil contains 108 soil trace elements, comprising the following steps: preparing a powder of nano-particles for the soil trace elements; and spraying the powder onto earth soil infertile, acidified, or contaminated by heavy metals, and through an antagonistic (exchange) effect of the soil trace elements incurred by the powder (electrolyte) potential, the earth soil is recovered, so that in growing a crop, even if the earth soil is contaminated by heavy metals, the heavy metals are not absorbed, the crop grows by absorbing the added soil trace elements in the soil.

In an embodiment of the present invention, the powder contains 26 active soil trace elements that can be quantified, and that include: iron (Fe), nickel (Ni), manganese (Mn), copper (Cu), zinc (Zn), boron (B), molybdenum (Mo), chlorine (Cl), oxygen (O), sodium (Na), magnesium (Mg), aluminum (Al), silicon (Si), a phosphorus (P), sulfur (S), potassium (K), calcium (Ca), scandium (Sc), titanium (Ti), chromium (Cr), vanadium (V), gallium (Ga), selenium (Se), germanium (Ge), lanthanum (La), samarium (Sm), and cobalt (Co), the active soil trace elements act in cooperation with various probiotic micro-organism groups, and through the inter-molecular antagonism/coordination/absorption/penetration, an earth soil structure is restored, to recover the earth soil for repeated usages, hereby strengthening constitution of a crop, and raising its quality and yield.

Once the structure of earth soil is changed, the earth soil may get in touch with air, water, and fertilizer, so that it is easier to grow a crop. Through the attractions between the earth soil molecules, the soil trace elements are able to penetrate into the earth soil, to turn the earth soil into loose flakes.

The particle of earth soil carries positrons and electrons at the same time, when the pH value is raised, that induces the nitride to release a (positively charged) proton (releasing H+), thus itself becomes negatively charged, to be helpful in absorbing cation. On the contrary, when the pH value is lowered, the NH₂ will accept proton to become positively charged, to be helpful in absorbing anion.

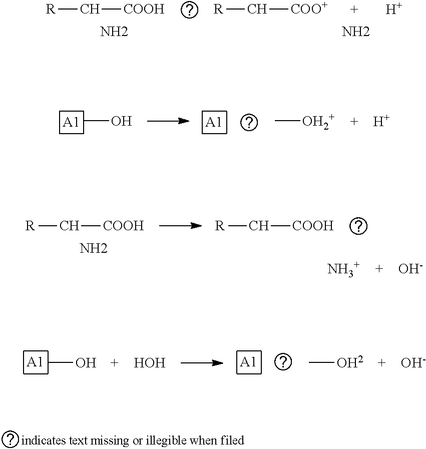

Based on the oxidation-reduction potential of the earth soil, the permeability of the earth soil can be classified into four categories: 1. earth soil of good permeability for (oxidation-reduction potential of) +700 mv to +400 mv; 2. moderately reduced earth soil for +400 mv to +100 mv; 3. normally reduced earth soil for +100 mv to −100 mv; 4. well reduced earth soil for −100 mv to −300 mv. In general, at oxidation-reduction potential of +340 mv, the oxygen contents in earth soil is still sufficient. When the oxidation-reduction potential is at +225 mv, nitride starts to be reduced; at +200 mv, the Mn ion starts to be reduced; at +120 mv, the iron ion starts to be reduced; and finally at −150 mv, sulfate starts to be reduced to produce antagonistic (exchange) effect, to restore the earth soil back to acid-base balance.

When the powder is sprayed onto the earth soil, the oxidation-reduction potential of the earth soil is turned to −150 mv. At this time, sulfate is reduced to produce the antagonistic effect, to restore the earth soil to acid-base balance.

The powder is formed through sintering it in a temperature of 1200° C. to 1600° C., to form into granules 11 (such as of a round spherical shape, a rectangular body shape, a triangular body shape, and an elongated body shape) as shown in FIG. 1. The sintered, granular-shape soil trace element may produce fertility light wave of infrared light. By placing the granular-shape soil trace elements into soil of flower pot, hydroponics vegetables, cultivating crops, such elements could help the growth of a plant, and reduce and restore the soil being acidified, infertile, or contaminated by heavy metals. Further, by putting the granular-shape soil trace elements into an aquaculture pond, it could activate the water and improve its quality, in achieving green energy environment protection.

The functions of various soil trace elements are described as follows: The soil trace element of Fe: it is used to form chlorophyll and enzyme. The soil trace element of Ni: it is an ingredient of enzyme, and is related to the metabolism of urea. The soil trace element of Mn: it is used as an activating agent of enzyme, essential in the photosynthesis and respiration. The soil trace element of Cu: it is used as an ingredient of Oxidase, and is essential in the photosynthesis and respiration, and it could enhance utilization of protein by a plant. The soil trace element of Zn: it is used as a coenzyme for physiological function of a plant, and is used to form autologous growth hormone of plant, and it is related to carbohydrate metabolism. The soil trace element of B: it helps absorption of inorganic nutrient for a plant, formation of cell membrane, syntheses of carbohydrate, and the growths of fruits and seeds. The soil trace element of Mo: it is used for fixing and transforming nitrogen for a plant, to form vitamin C, and is related to photosynthesis and respiration. The soil trace element of Cl: it is used to absorb water, perform photosynthesis, regulate pH value of a plant, and is an ingredient of growth hormone.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. An American high-tech earth soil recovery method, characterized in that, earth soil contains 108 soil trace elements, comprising the following steps:
preparing a powder of nanoparticles for the soil trace elements; and
spraying the powder onto the earth soil infertile, acidified, or contaminated by heavy metals, and through an antagonistic (exchange) effect of the soil trace elements incurred by the powder (electrolyte) potential, the earth soil is recovered, so that in growing a crop, even if the earth soil is contaminated by heavy metals, the heavy metals are not absorbed, and the crop grows by absorbing the added soil trace elements in the earth soil.

2. The American high-tech earth soil recovery method as claimed in claim 1, wherein the powder contains 26 active soil trace elements that are quantified, and that include: iron (Fe), nickel (Ni), manganese (Mn), copper (Cu), zinc (Zn), boron (B), molybdenum (Mo), chlorine (Cl), oxygen (O), sodium (Na), magnesium (Mg), aluminum (Al), silicon (Si), a phosphorus (P), sulfur (S), potassium (K), calcium (Ca), scandium (Sc), titanium (Ti), chromium (Cr), vanadium (V), gallium (Ga), selenium (Se), germanium (Ge), lanthanum (La), samarium (Sm), and cobalt (Co), the active soil trace elements act in cooperation with various probiotic micro-organism groups, and through the inter-molecular antagonism/coordination/absorption/penetration, an earth soil structure is restored, to recover the earth soil for repeated usages, thus strengthening constitution of the crop, and raising its quality and yield.

3. The American high-tech earth soil recovery method as claimed in claim 1, wherein when the powder is sprayed onto the earth soil, an oxidation-reduction potential of the earth soil is turned to −150 mv, at this time, sulfate is reduced to produce the antagonistic effect, to restore the earth soil to acid-base balance.

4. The American high-tech earth soil recovery method as claimed in claim 1, wherein the powder is formed through sintering it in a temperature of 1200° C. to 1600° C., to form into a granular-shape.
